(19) United States
(12) Patent Application Publication
(10) Pub. No.: US 2019/0295178 A1
(43) Pub. Date: Sep. 26, 2019

(54) DRIVING EVALUATION APPARATUS, DRIVING EVALUATION SYSTEM, AND PROGRAM

(71) Applicant: HONDA MOTOR CO., LTD., Tokyo (JP)

(72) Inventor: Tomoya Komizo, Wako-shi (JP)

(21) Appl. No.: 16/353,100

(22) Filed: Mar. 14, 2019

(30) Foreign Application Priority Data
Mar. 26, 2018 (JP) 2018-058934

(51) Int. Cl. G06Q 40/08; B60W 50/14; B60W 40/09

(52) U.S. Cl. CPC G06Q 40/08; B60W 2050/146; B60W 40/09; B60W 50/14

(57) ABSTRACT

A driving evaluation apparatus includes: a driving evaluation acquisition part that is configured to acquire a driving evaluation result which is obtained by evaluating a driving of a driver of a vehicle; and a driving evaluation output part that is configured to output the acquired driving evaluation result, wherein the driving evaluation output part is configured to combine and output the driving evaluation result and information relating to an insurance premium regarding the driving in a case where the acquired driving evaluation result satisfies a predetermined condition.

### CROSS-REFERENCE TO RELATED APPLICATION

Priority is claimed on Japanese Patent Application No. 2018-058934, filed on Mar. 26, 2018, the contents of which are incorporated herein by reference.

### BACKGROUND

### Field of the Invention

The present invention relates to a driving evaluation apparatus, a driving evaluation system, and a program.

### Background

A driving evaluation apparatus (driving evaluation system) determines a driving situation of a driver on the basis of driving availability information that is received from an on-vehicle terminal. As a driving evaluation system, such a system is known that provides, by way of an insurance company terminal, calculating an insurance premium of an automobile insurance on the basis of a determination result that is received from a driving management server, presenting the calculated insurance premium to a driver (user), discounting the insurance premium depending on whether the driving situation is good or bad, and the like (refer to Japanese Unexamined Patent Application, First Publication No. 2002-149984).

### SUMMARY

However, according to the related art, the insurance premium is merely presented, and a relationship between a point (skill) that is evaluated as a good driving and the reduction of the insurance premium is not found. Therefore, there may be cases in which it may be impossible to provide valuable information to the driver, which may not lead to further improvement of a driving skill of the driver.

An object of an aspect of the present invention is to provide a driving evaluation apparatus, a driving evaluation system, and a program capable of providing further valuable information to a driver.

(1) A driving evaluation apparatus according to an aspect of the present invention includes: a driving evaluation acquisition part that is configured to acquire a driving evaluation result which is obtained by evaluating a driving of a driver of a vehicle; and a driving evaluation output part that is configured to output the acquired driving evaluation result, wherein the driving evaluation output part is configured to combine and output the driving evaluation result and information relating to an insurance premium regarding the driving in a case where the acquired driving evaluation result satisfies a predetermined condition.

(2) In the driving evaluation apparatus of (1) described above, the driving evaluation output part may combine and output the driving evaluation result and the information relating to the insurance premium in a case where a value that is indicated by the driving evaluation result is equal to or more than a predetermined value.

(3) The driving evaluation apparatus of (1) or (2) described above may further include a driving information acquisition part that is configured to acquire driving information relating to the driving of the driver of the vehicle.

(4) In the driving evaluation apparatus of (1) to (3) described above, the driving evaluation output part may generate information for displaying the driving evaluation result which is stored in a storage part and the information relating to the insurance premium in a same screen.

(5) In the driving evaluation apparatus of (1) to (4) described above, the driving evaluation output part may further include a display part that is configured to display the driving evaluation result which is stored in a storage part and the information relating to the insurance premium.

(6) In the driving evaluation apparatus of (4) or (5) described above, at least one of contact information of the driver of the vehicle and contact information of a payer of the insurance premium of the vehicle and an owner of the vehicle may be stored in the storage part as one or more output destinations of information of one or both of the driving evaluation result and the information relating to the insurance premium regarding the driving, and the driving evaluation output part may output the driving evaluation result and the information relating to the insurance premium to at least one of the output destinations.

(7) The driving evaluation apparatus of (6) described above may include: a response acquisition part that is configured to acquire a response of the owner of the vehicle to the driving evaluation result which is output by the driving evaluation output part; and a point process part that is configured to give a point to the owner of the vehicle when acquiring the response of the owner of the vehicle to the driving evaluation result which is output by the driving evaluation output part, wherein the point may be assigned to part of the output insurance premium, and the insurance premium may be set to be reduced by the point.

(8) A driving evaluation system according to another aspect of the present invention includes: a driving information acquisition part that is configured to acquire driving information relating to a driving of a driver of a vehicle; a driving evaluation calculation part that is configured to calculate a driving evaluation result which is obtained by evaluating the driving of the driver according to the driving information that is acquired by the driving information acquisition part; and a driving evaluation output part that is configured to output the driving evaluation result which is calculated by the driving evaluation calculation part, wherein the driving evaluation output part is configured to combine and output the driving evaluation result and information relating to an insurance premium regarding the driving in a case where the driving evaluation result that is calculated by the driving evaluation calculation part satisfies a predetermined condition.

(9) Still another aspect of the present invention is a computer-readable non-transitory recording medium which includes a program that is configured to cause a computer to execute steps of: acquiring driving information relating to a driving of a driver of a vehicle; acquiring a driving evaluation result which is an evaluation result of the driving of the driver according to the acquired driving information; and outputting the acquired driving evaluation result, and combining and outputting the driving evaluation result and information relating to an insurance premium regarding the driving in a case where the acquired driving evaluation result satisfies a predetermined condition.

According to the configurations (1) to (9) described above, it is possible to provide a driving evaluation apparatus, a driving evaluation system, and a program capable of providing further valuable information to a driver.

### BRIEF DESCRIPTION OF THE DRAWINGS

FIG. 1 is a configuration view of a driving evaluation system according to a first embodiment.

FIG. 2 is a configuration view of a terminal apparatus according to the first embodiment.

FIG. 3 is a configuration view of a server apparatus according to the first embodiment.

FIG. 4 is a flowchart showing an example of a flow of a process relating to a driving evaluation according to the first embodiment.

FIG. 5 is a flowchart showing an example of a flow of a process in which a travel evaluation process is ended according to the first embodiment.

FIG. 6 is a flowchart showing an example of a flow of an output process of an evaluation result according to the first embodiment.

FIG. 7A is a view showing an image showing an evaluation result according to the first embodiment.

FIG. 7B is a view showing an image showing an evaluation result according to the first embodiment.

FIG. 7C is a view showing an image showing an evaluation result according to the first embodiment.

FIG. 8 is a view showing the usefulness of the driving evaluation system according to the first embodiment.

FIG. 9 is a configuration view of an in-vehicle information apparatus according to a second embodiment.

FIG. 10 is a configuration view of a terminal apparatus according to a third embodiment.

FIG. 11 is a configuration view of a server apparatus according to the third embodiment.

FIG. 12 is a view showing an evaluation result image showing information relating to an insurance contract according to a fourth embodiment.

FIG. 13 is a flowchart showing an example of a flow of a synthesis process of the evaluation result image according to the fourth embodiment.

FIG. 14 is a view showing a condition for determining an output destination according to the fourth embodiment.

FIG. 15A is a view showing a usage mode according to the fourth embodiment.

FIG. 15B is a view showing a usage mode according to the fourth embodiment.

FIG. 15C is a view showing a usage mode according to the fourth embodiment.

FIG. 16 is a configuration view of a server apparatus that is applied to a modified example (Case 3) according to the fourth embodiment.

FIG. 17 is a view showing an image showing an evaluation result according to the fourth embodiment.

### DESCRIPTION OF THE EMBODIMENTS

Hereinafter, a driving evaluation apparatus, a driving evaluation system, and a program according to embodiments will be described with reference to the drawings. In the following description of the embodiments, “according to at least any one or both of data A and data B that is generated directly or indirectly from the data A”, “according to data that includes at least data A and includes data B which is different from the data A depending on a predetermined condition or the like”, arbitrary combination of the above, and the like may be referred to simply as “according to data A”.

### First Embodiment

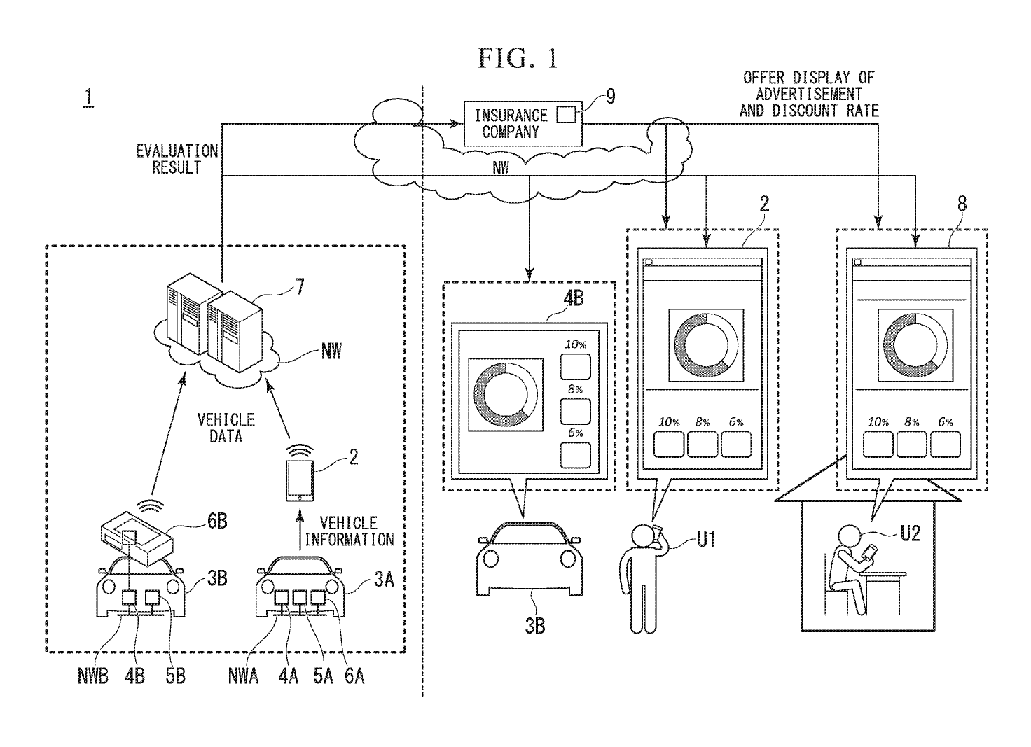

FIG. 1 is a configuration view of a driving evaluation system according to a first embodiment. In FIG. 1, a plurality of vehicles relating to the driving evaluation system, a server apparatus 7, a second terminal apparatus 8, and an insurance premium calculation apparatus 9 are shown. The vehicle is, for example, a movable body (an automobile, a motorcycle, and the like) that travels on a road.

An in-vehicle information apparatus 4A, an ECU (electronic control unit) 5A, and a communication apparatus 6A are mounted on a vehicle 3A. A first terminal apparatus 2 is brought into the vehicle 3A by a user U1 at the time of driving.

The user U1 drives the vehicle 3A or a vehicle 3B. The user U1 is a beginner at driving, a person who is in a learning stage of a driving skill, and the like. For example, the user U1 is a young person (child), and a user U2 is his/her parent.

Hereinafter, the driving evaluation system of the embodiment will be described separately in some case examples.

First, a driving evaluation system 1 of the first embodiment is described. The driving evaluation system 1 includes at least the first terminal apparatus 2 (driving evaluation apparatus), the server apparatus 7, and the second terminal apparatus 8. The server apparatus 7 described below is an example of a driving evaluation apparatus.

The first terminal apparatus 2 is a portable terminal apparatus that is possessed by the user U1. The first terminal apparatus 2 is, for example, a smartphone, a tablet terminal, or the like.

The in-vehicle information apparatus 4A, the ECU 5A, and the communication apparatus 6A are mutually connected by a network NWA inside the vehicle 3A. The in-vehicle information apparatus 4A includes a display part that displays information to at least a passenger and allows the display unit to display information relating to the vehicle 3A. The ECU 5A performs communication at an arbitrary timing and controls driving, braking, steering, and the like of the vehicle 3A. The communication apparatus 6A communicates with the first terminal apparatus 2 and thereby transmits travel information relating to control information that is generated by the ECU 5A to the first terminal apparatus 2. It is assumed that the vehicle 3A does not include a functional part that communicates with the server apparatus 7, and it is assumed that the in-vehicle information apparatus 4A is not included in an output destination of the present system.

The server apparatus 7 is connected to the first terminal apparatus 2, the second terminal apparatus 8, a communication apparatus 6B of the vehicle 3B described later, and the like via a network NW and communicates with each of the apparatuses. The server apparatus 7 acquires data indicating a driving situation of the vehicle that is provided from the first terminal apparatus 2 or the communication apparatus 6B and the like and outputs an evaluation result of the driving skill. Details thereof will be described later.

The second terminal apparatus 8 is a terminal apparatus that is operated by the user U2. A form of the second terminal apparatus 8 is arbitrary, and the second terminal apparatus 8 may be portable or stationary. The user U2 operates the second terminal apparatus 8 and thereby browses information that is provided from the server apparatus 7 and the like.

### [First Terminal Apparatus 2]

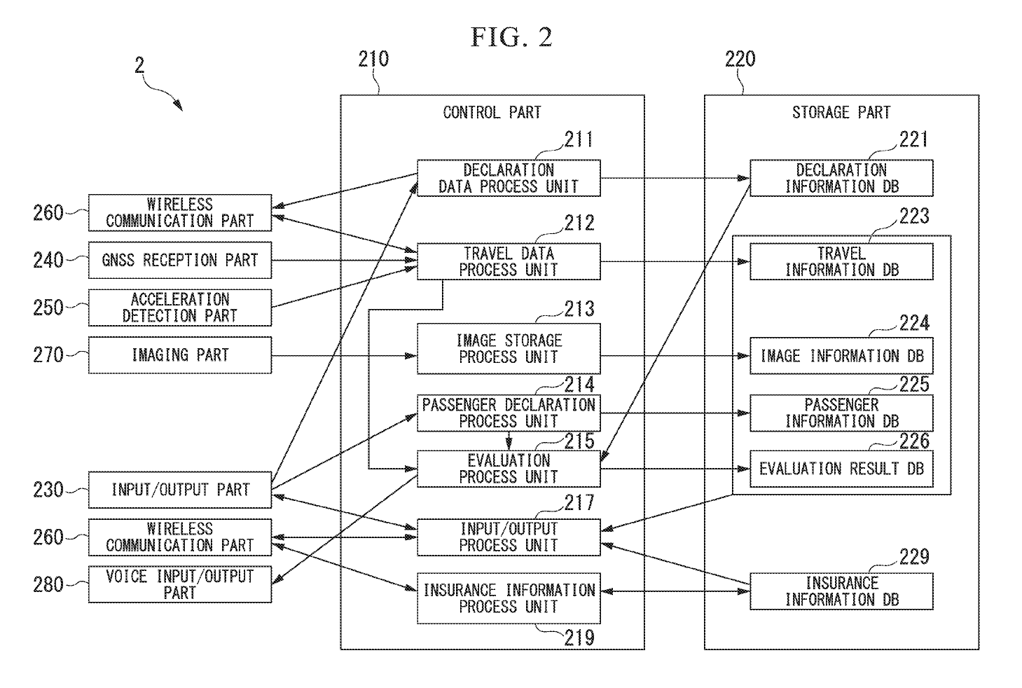

FIG. 2 is a configuration view of a terminal apparatus according to the first embodiment. The first terminal apparatus 2 includes, for example, a control part 210, a storage part 220, an input/output part 230, a GNSS reception part 240, an acceleration detection part 250, a wireless communication part 260, an imaging part 270, and a voice input/output part 280.

The control part 210 includes a processor that executes a software program and the like. The control part 210 executes the software program and thereby functions as a functional part of a variety of processes.

The storage part 220 is realized by a ROM (Read Only Memory), a RAM (Random Access Memory), a HDD (Hard Disk Drive), a flash memory, or the like. The software program that is executed by the processor may be stored in the storage part 220 in advance or may be downloaded from an external apparatus, a portable storage medium, or the like or via a communication line. The storage part 220 stores a variety of setting information for allowing the first terminal apparatus 2 to function as a communication terminal and a basic program such as an OS.

The input/output part 230 includes a display part (not shown) such as a liquid crystal display that displays a variety of information and an operation detection part (not shown). The input/output part 230 may be constituted as a touch panel.

The GNSS (Global Navigation Satellite System) reception part 240 receives a signal that is transmitted by a GNSS satellite, specifies a position of the GNSS reception part 240 on the basis of the received signal, and outputs information (hereinafter, referred to as position information) indicating the position.

The acceleration detection part 250 includes an acceleration sensor (or a gyro sensor) and detects a physical quantity such as an acceleration that acts on the first terminal apparatus 2.

The wireless communication part 260 includes an antenna (not shown) and performs communication by a wireless communication method such as a cellular method or a wireless LAN method. The wireless communication part 260 may further perform communication using a short-range wireless communication method such as Bluetooth (registered trademark).

The imaging part 270 is, for example, a digital camera such as a CCD (Charge Coupled Device) camera or a CMOS (Complementary Metal Oxide Semiconductor) camera. The imaging part 270 records an image around the vehicle 3A as a moving image or a semi-moving image by a control of the control part 210, for example, during a period in which the user U1 is driving the vehicle 3A. The imaging part 270 may be a separate body from a main body of the first terminal apparatus 2.

The voice input/output part 280 includes a microphone, a speaker, and the like which are not shown and is used for, for example, a telephone conversation. The voice input/output part 280 may output an alarm sound or the like from the speaker or the like by the control of the control part 210.

The control part 210 includes, for example, a declaration data process unit 211, a travel data process unit 212 (driving information acquisition part), an image storage process unit 213, a passenger declaration process unit 214, an evaluation process unit 215 (driving evaluation calculation part).

The storage part 220 stores, for example, a declaration information DB (database) 221, a travel information DB 223, an image information DB 224, a passenger information DB 225, an evaluation result DB 226, an insurance information DB 229, and the like. The travel information DB 223 and the image information DB 224 are an example of “information relating to a driving situation”. The travel information DB 223, the image information DB 224, the passenger information DB 225, and the evaluation result DB 226 are an example of “vehicle data”.

The declaration data process unit 211 acquires a variety of declaration information that is registered by the user U1 operating the input/output part 230 and adds the variety of declaration information to the declaration information DB 221.

For example, the variety of declaration information include attribution information of the user U1, output destination information relating to an output destination of an evaluation result, range information indicating a range in which the driving of the vehicle 3A (or 3B) is allowed, speed limit information, and the like. For example, the output destination information includes a name of the user U1, contact information (for example, an e-mail address) of the user U1, a name of the user U2, contact information (for example, an e-mail address) of the user U2, timing information for each output destination indicating an output timing, and the like. The range information includes latitude and longitude information, identification information that designates a region, or the like. For example, a threshold value for determination is stored in the speed limit information. The declaration data process unit 211 transmits the acquired variety of information to the server apparatus 7.

The travel data process unit 212 generates travel data indicating a travel situation of the vehicle 3A on the basis of a variety of data that are acquired via the wireless communication part 260 from the vehicle 3A and adds the travel data to the travel information DB 223. For example, the travel information DB 223 includes items such as identification information of the vehicle 3A, a speed of the vehicle 3A, a rotation speed of an engine, date and time information at the time of traveling, position information (position information of the GNSS reception part 240, and the like) of the vehicle 3A, and acceleration information. For example, the travel data process unit 212 adds acceleration information according to the acceleration that acts on the first terminal apparatus 2 and that is acquired from the acceleration detection part 250 and the like to the travel information DB 223.

The image storage process unit 213 adds image data of the imaging part 270 or a camera (not shown) that is mounted on the vehicle 3A to the image information DB 224. For example, the image data includes items such as the identification information of the vehicle 3A, image information of a situation around the vehicle 3A, and the date and time information at the time of traveling.

The passenger declaration process unit 214 acquires information relating to the passenger that is registered by the user U1 operating the input/output part 230 and adds the information relating to the passenger to the passenger information DB 225. For example, the passenger information DB 225 includes items such as information (information relating to whether or not an instructor or a parent having a driving experience rides together) relating to the passenger and a period during which the passenger rides together. For example, it is identified whether or not the instructor or the parent having a driving experience rides together on the vehicle 3A by analyzing the information relating to the passenger at the time of driving corresponding to a specified date and time.

The evaluation process unit 215 generates evaluation data indicating an evaluation result of an evaluation item relating to the travel situation of the vehicle 3A on the basis of the variety of data that are acquired from each of the travel data process unit 212 and the passenger declaration process unit 214 and adds the evaluation data to the evaluation result DB 226. A known method may be used for a method of evaluation with respect to the evaluation item described above.

The evaluation result DB 226 includes a plurality of evaluation items. For example, the evaluation result DB 226 includes the identification information of the vehicle 3A and the evaluation result for each of the evaluation items (hereinafter, simply referred to as the evaluation result). The evaluation items include, for example, history information of a specific event (sudden braking, rapid acceleration, or the like) and speeding, date and time information at the time of traveling, a degree of concentration for strictly carrying out safe driving, the presence or absence of seat belt wearing, whether or not a person having an abundant driving experience rides together, a time band of driving, the presence or absence of traveling outside a driving allowed range, and the like. The evaluation process unit 215 may specify the degree of concentration for strictly carrying out safe driving from a time of the telephone conversation using the first terminal apparatus 2 during the driving, or the like.

For example, the evaluation process unit 215 acquires the range information that is declared by the user U1 from the declaration information DB 221 and determines the presence or absence of traveling outside the driving allowed range on the basis of the acquired range information. For example, the evaluation process unit 215 acquires a speed limit value that is set in advance from the declaration information DB 221 and determines speeding on the basis of the speed limit value. The declaration data process unit 211 may acquire the above-described speed limit value from the second terminal apparatus 8 or the like and add the speed limit value to the declaration information DB 221. In this case, the declaration data process unit 211 may exclude a rewrite request from the first terminal apparatus 2 with respect to the speed limit value.

The input/output process unit 217 transmits the vehicle data described above to the server apparatus 7 through the wireless communication part 260, generates an image according to the vehicle data, and allows the input/output part 230 to display the image.

The input/output process unit 217 receives the information that is provided from the server apparatus 7 via the wireless communication part 260 and allows the input/output part 230 to display the information. The input/output process unit 217 transmits the information according to the operation of the user U1 that is detected by the input/output part 230 to the server apparatus 7 using the wireless communication part 260.

When the input/output process unit 217 detects an event that is considered to be caused by a driver's forgetting or overlooking in the result that is detected by the evaluation process unit 215, the input/output process unit 217 may allow the input/output part 230 to display an alerting indication or may output an alerting message or an alarm sound from the voice input/output part 280.

An insurance information process unit 219 acquires information relating to an insurance premium (insurance premium regarding the driving) of an automobile insurance that is provided from an insurance company or the like via the wireless communication part 260 and stores the information relating to the insurance premium in the insurance information DB 229.

### [Server Apparatus 7]

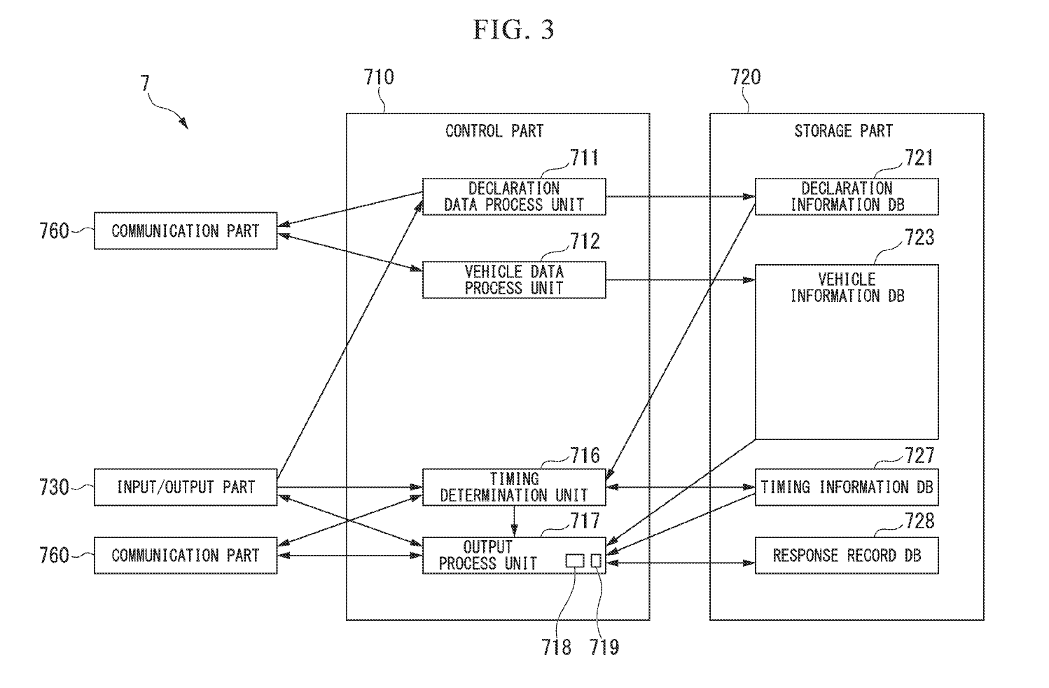

Next, the server apparatus according to the first embodiment is described. FIG. 3 is a configuration view of the server apparatus according to the first embodiment. The server apparatus 7 includes, for example, a control part 710, a storage part 720, an input/output part 730, and a communication part 760.

The control part 710 includes a processor that executes a software program and the like. The control part 710 functions as a functional part of a variety of processes by executing the software program.

For example, the server apparatus 7 may also have functions of a web server, a database server, an authentication server, and the like.

The storage part 720 is realized by a ROM, a RAM, an HDD, a flash memory, and the like. The software program that is executed by the processor may be stored in the storage part 720 in advance or may be downloaded from an external apparatus, a portable storage medium, or the like or via a communication line.

The storage part 720 stores a variety of setting information for allowing the server apparatus 7 to function as a processing apparatus and a basic program such as an OS. In addition to the above, the storage part 720 stores an application program and a variety of information for realizing a main function of the driving evaluation system 1.

The input/output part 730 includes a display part, a keyboard, and the like, which are not shown in the drawing. The input/output part 730 accepts an operation to the server apparatus 7, notifies the control part 710 of the operation, and displays a control state by the control from the control part 710.

The communication part 760 is connected to the network NW and communicates with each apparatus via the network NW. For example, a variety of generally known methods may be applied to a communication method with the network NW. For example, the server apparatus 7 is able to be appropriately selected without being limited by a position at which the server apparatus 7 is physically arranged as long as the server apparatus 7 is able to perform communication via the network NW.

The control part 710 of the server apparatus 7 includes, for example, a declaration data process unit 711, a vehicle data process unit 712 (driving information acquisition part), a timing determination unit 716, an output process unit 717 (driving evaluation calculation part, evaluation result output part). The output process unit 717 may include, for example, a response acquisition section 718 and a point process section 719. This will be described later.

The declaration data process unit 711 acquires a variety of declaration information from the first terminal apparatus 2 and adds the variety of declaration information to a declaration information DB 721.

The vehicle data-process unit 712 acquires the vehicle data from the first terminal apparatus 2 and adds the vehicle data to a vehicle information DB 723.

The storage part 720 stores the declaration information DB 721, the vehicle information DB 723, a timing information DB 727, a response record DB 728, and the like.

For example, the timing determination unit 716 determines a timing at which the evaluation result and the like are output on the basis of the timing information of each output destination that is included in the declaration information DB 721 and registers the result to the timing information DB 727 for each output destination. The data that is registered to the timing information DB 727 may be a value of a frequency relating to the determined timing and may include, for example, a value of a first frequency of a first output destination (the user U1), a value of a second frequency of a second output destination (the user U2), and the like. Hereinafter, the value of the frequency is simply referred to as a frequency.

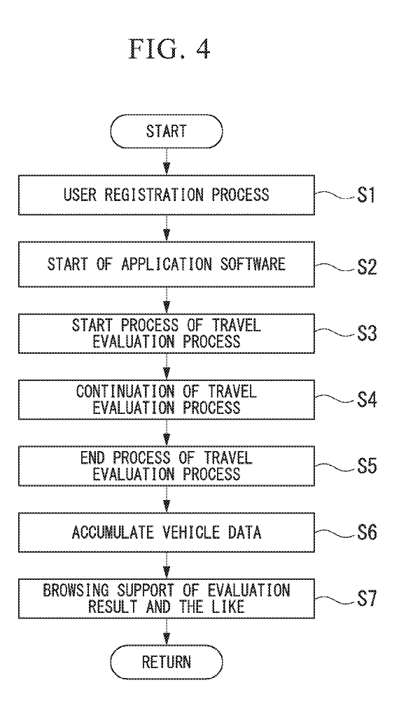

Next, a flow of a process relating to the driving evaluation according to the first embodiment is described with reference to FIG. 4. FIG. 4 is a flowchart showing an example of the flow of the process relating to the driving evaluation according to the first embodiment. Within a range where there is no inconsistency in each process, the processes may be performed in parallel, or an order of the processes may be changed. In order to simplify the description of the embodiment, an example in which the above-described processes are organized as a successive process is described.

First, the driving evaluation system 1 performs a user registration process in advance and obtains information relating to the user U1 (Step S1). For example, the server apparatus 7 of the driving evaluation system 1 determines a frequency of each output destination that is designated by the user U1 on the basis of the obtained information.

Next, the first terminal apparatus 2 activates the application software by detecting the operation of the user U1 (Step S2). Next, the control part 210 of the first terminal apparatus 2 performs a start process of a travel evaluation process (Step S3). The travel evaluation process includes an acquisition process and a record process of information relating to the driving situation, an evaluation process relating to the evaluation item, a record process to the storage part of the evaluation result, and the like. Here, the acquisition process and the record process of the information relating to the driving situation among the above-described processes are started.

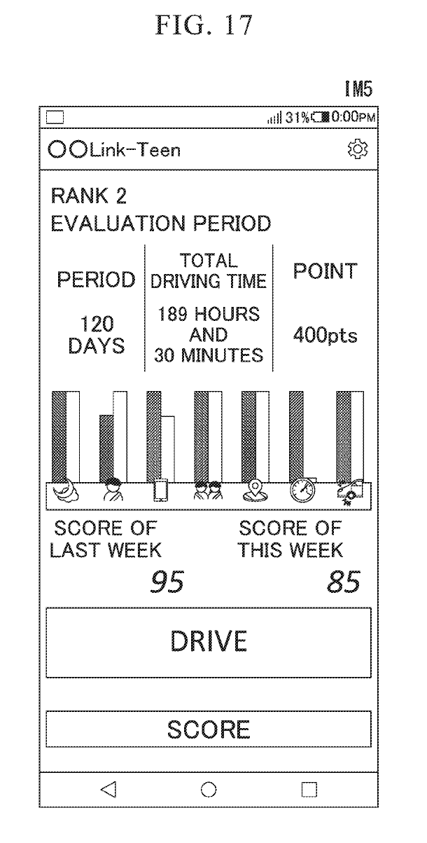

For example, the start process of the travel evaluation process is performed through a login process of the driving evaluation system 1 and detection of a driving start (Drive) button operation in a state in which an evaluation result image (FIG. 17) is displayed on the input/output part 230. Such processes are performed before the user U1 starts driving of the vehicle 3A. In accordance with the start of the travel evaluation process, the input/output process unit 217 detects the operation of the driving start by the user U1 and starts the acquisition process and the record process of the information relating to the driving situation of the travel evaluation process.

Next, the control part 210 continues the travel evaluation process (the acquisition process and the record process of the information relating to the driving situation) described above (Step S4). During this time, the user U1 drives the vehicle 3A. The operation of the first terminal apparatus 2 during the driving, that is, the operation to the driving evaluation system 1 is not required.

Next, the control part 210 ends the travel evaluation process by detecting the operation of the user U1 (Step S5).

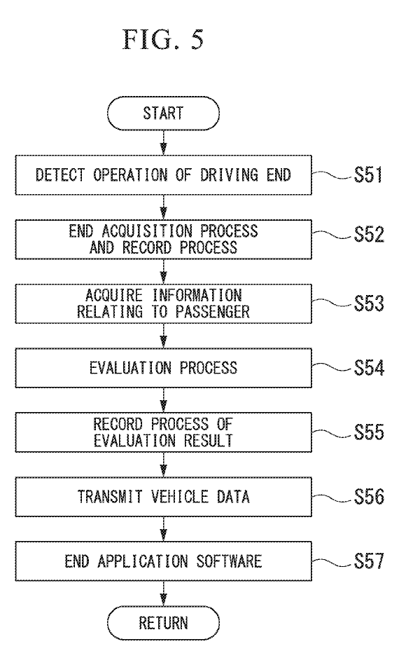

For example, the process in which the travel evaluation process is ended is implemented in the following procedure. FIG. 5 is a flowchart showing an example of a flow of a process in which the travel evaluation process is ended. First, the control part 210 detects the operation of the driving end by the user U1 (Step S51) and ends the acquisition process and the record process of the information relating to the driving situation that are continuously performed (Step S52). The passenger declaration process unit 214 of the control part 210 acquires the information relating to the passenger and registers the information relating to the passenger to the passenger information DB (Step S53). Then, the evaluation process unit 215 of the control part 210 performs the evaluation process relating to the evaluation item (Step S54) and performs the record process to the storage part of the evaluation result (Step S55). Next, the input/output process unit 217 of the control part 210 transmits the vehicle data including the evaluation result to the server apparatus 7 (Step S56). The control part 210 ends the application software (Step S57).

With reference back to FIG. 4, next, the server apparatus 7 acquires the vehicle data from the first terminal apparatus 2, registers the vehicle data to the vehicle information DB 723, and thereby, accumulates the vehicle data (Step S6).

For example, each time the user U1 drives the vehicle 3A, the processes from Step S2 to Step S6 described above are repeated, and thereby, the vehicle data relating to the driving evaluation of the user U1 is accumulated in the server apparatus 7.

Next, the driving evaluation system 1 performs a process for supporting the browsing of the evaluation result and the like by the user U1 (Step S7).

For example, the server apparatus 7 transmits the evaluation result according to the vehicle data that is acquired from the first terminal apparatus 2 and a full period evaluation result according to the evaluation result of a predetermined period to the output destination at a predetermined timing that is set in advance and allows the evaluation result and the full period evaluation result to be output at each output destination. The evaluation result and the full period evaluation result are collectively referred to as the evaluation result and the like. For example, the evaluation result and the like are distributed to the first terminal apparatus 2 and the second terminal apparatus 8 that are designated as the output destination, and browsing of the evaluation result and the like is permitted.

The predetermined period described above is, for example, a period from when the full period evaluation result is previously output to when the full period evaluation result is currently output and is an example of an evaluation target period. The evaluation target period is determined to be a length that includes a result of driving of one time or a plurality of times. When an evaluation target period of the first output destination is shorter than an evaluation target period of the second output destination, the first frequency of the first output destination (the user U1) is made higher than the second frequency of the second output destination (the user U2).

As described above, by determining the evaluation target period and calculating the full period evaluation result, it is possible to obtain the full period evaluation result in which the driving situations of at least a plurality of times are summed and quantified.

After the end of driving, the user U1 voluntarily refers to the evaluation result and the like relating to the driving described above from the first terminal apparatus 2 and checks the driving situation. Alternatively, the server apparatus 7 outputs a guide prompting the checking of the evaluation result and the like to the first terminal apparatus 2 at a predetermined timing that is defined by the first frequency and supports the browsing of the evaluation result and the like by the user U1. For example, the user U1 may browse any one or both of the evaluation result relating to the driving of the day and the full period evaluation result after returning home or the like.

When the user U2 is notified of the evaluation result and the like from the user U1, for example, in a case such as where the user U2 acquires any one or both of the evaluation result and the like that are transmitted from the server apparatus 7 at a predetermined timing that is defined by the second frequency and the guide prompting the checking of the evaluation result and the like, the user U2 may browse the information relating to the evaluation result and the like that are output by the server apparatus 7.

The server apparatus 7 may send the full period evaluation result to an insurance company by the declaration (designation) from the user U1 or U2. When the full period evaluation result is sent from the server apparatus 7 to the insurance company, an offer (including fees, a discount rate, and the like) about an insurance contract from the insurance company is delivered to one or both of the first terminal apparatus 2 and the second terminal apparatus 8. The users U1 and U2 are able to browse the content of the offer.

The content of the offer about the insurance contract from the insurance company is changed depending on the full period evaluation result that is sent to the insurance company. The users U1 and U2 are able to estimate whether the full period evaluation result is good or bad from the content of the offer.

Next, a process of the browsing support of the evaluation result and the like according to the first embodiment is described.

The output process unit 717 of the server apparatus 7 generates the full period evaluation result of the evaluation target period on the basis of the vehicle data within the evaluation target period among the vehicle data that are stored in the vehicle information DB 723 as a history of driving and outputs the full period evaluation result to each output destination.

For example, when the output process unit 717 outputs the full period evaluation result to the first terminal apparatus 2, the output process unit 717 outputs the full period evaluation result at the first frequency F1. For example, an evaluation target period T1 in this case is determined so as to be within an interval of the first frequency F1. The first frequency F1 may be the same as or different from the first frequency of a case where any one or both of the evaluation result and the like and the guidance prompting the checking of the evaluation result and the like are transmitted from the server apparatus 7.

When the output process unit 717 outputs the full period evaluation result to the second terminal apparatus 8, the output process unit 717 outputs the full period evaluation result at the second frequency F2. For example, an evaluation target period T2 in this case is determined by the second period T2 or the like that is defined by the second frequency F2. The second frequency F2 may be the same as or different from the second frequency of a case where any one or both of the evaluation result and the like and the guidance prompting the checking of the evaluation result and the like are transmitted from the server apparatus 7.

The response acquisition section 718 of the output process unit 717 may acquire a response to the output of the full period evaluation result and register the presence or absence of the response to the response record DB 728.

When the presence or absence of the response is registered, the timing determination unit 716 may determine the presence or absence of the response that is registered in the response record DB 728 and adjust the frequency at which the full period evaluation result is output. For example, when there is no response, the timing determination unit 716 may use the presence or absence of the response that is registered in the response record DB 728 for adjusting the timing when outputting the full period evaluation result to the output destination.

When there is no response, the timing determination unit 716 adjusts the timing such that one or both of the first frequency and the second frequency is higher than that or those of a case where there is the response. Thereby, it becomes possible to prompt the user U1 and the user U2 to view the evaluation result and the like.

The output process unit 717 may acquire information from the second terminal apparatus 8, transmit the information to the first terminal apparatus 2, and output the information to the input/output part 230. For example, the output process unit 717 may acquire information that is written on a comment input column or the like associated with an image that is displayed on the second terminal apparatus 8 side and may display the information on the input/output part 230 of the first terminal apparatus 2. Thereby, even when the user U1 and the user U2 do not face each other, the user U1 and the user U2 are able to interact with each other while presenting a display of the same contents on the first terminal apparatus 2 and the second terminal apparatus 8 and adding writings on the display or displaying a point corresponding to a topic.

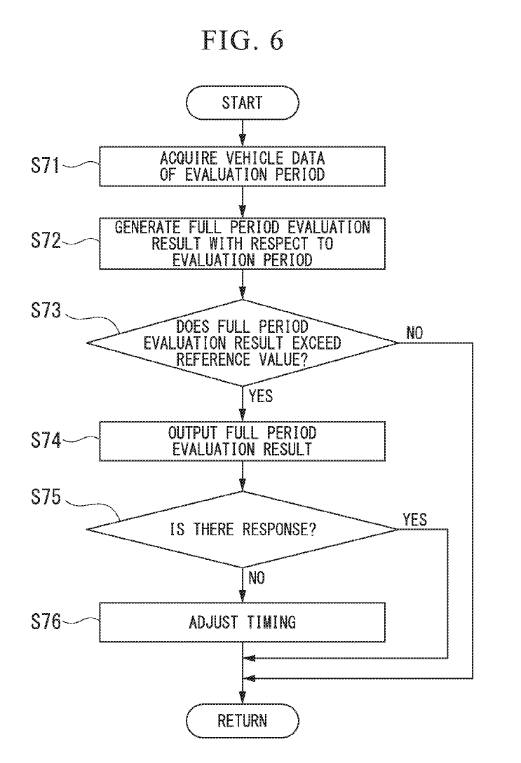

FIG. 6 is a flowchart showing an example of a flow of an output process of the evaluation result according to the first embodiment.

First, the output process unit 717 reads and acquires the vehicle data within the evaluation period from the vehicle information DB 723 (Step S71).

Next, the output process unit 717 generates the full period evaluation result corresponding to the evaluation target period on the basis of the vehicle data within the evaluation period (Step S72).

Next, the timing determination unit 716 determines whether or not the full period evaluation result exceeds a determination reference value (Step S73). When the full period evaluation result does not exceed the determination reference value, the timing determination unit 716 ends the process shown in FIG. 6. When the full period evaluation result exceeds the determination reference value, the output process unit 717 outputs a result of determination to an output destination that is set in advance (Step S74).

Next, the timing determination unit 716 determines whether or not there is a response (Step S75). When there is a response, the timing determination unit 716 ends the process shown in FIG. 6. When there is no response, the timing determination unit 716 adjusts the timing in accordance with a predetermined rule (Step S76) and ends the process shown in FIG. 6.

According to the process described above, the frequency at which the full period evaluation result is outputted of a case where there is no response is higher than that of a case where there is a response. Among the procedures described above, the full period evaluation result may be output regardless of the determination result of Step S73, and Steps S75 and S76 may be omitted.

When the full period evaluation result by the vehicle data process unit 712 is relatively high as compared with a past full period evaluation result, the timing determination unit 716 may allow the output frequency at which the guidance prompting the checking the evaluation result and the like is sent from the server apparatus 7 to be higher than that of a case where the full period evaluation result is relatively low. Thereby, since the guidance is sent at a high frequency in a case where the evaluation is improved, it is possible to enhance the motivation of a person to be evaluated.

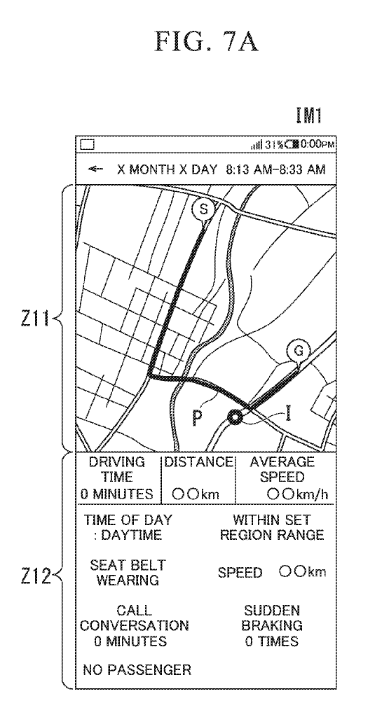

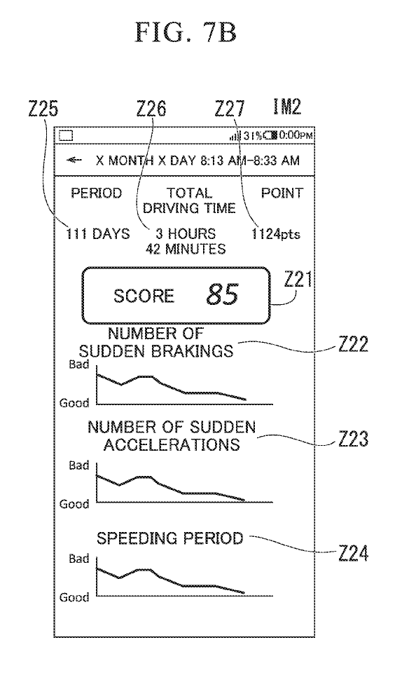

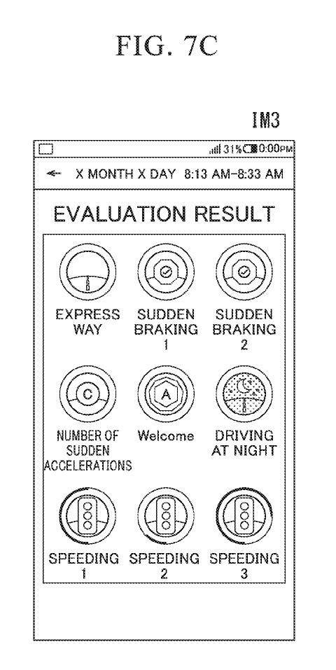

Next, the display of the evaluation result is described with reference to FIG. 7A to FIG. 7C. FIG. 7A to FIG. 7C are views showing an image showing an evaluation result according to the first embodiment.

An image IM1 shown in FIG. 7A is an example of an image in which a driving route is shown on a map Z11 and the evaluation result during driving of the driving route is also displayed. On the map Z11, a start point (step S) and a goal point (G) are shown, and a route (P) through which the vehicle travels from the start point to the goal point and a point (I) where an accident has occurred so far in a course of the route are displayed.

For example, the first terminal apparatus 2 displays this display screen on the display part as needed in response to the operation of the user U1.

The server apparatus 7 may transmit the display screen to the second terminal apparatus 8 when a provision to the user U2 is designated via the first terminal apparatus 2 and at a preset timing.

The user U2 is able to check the image IM1 as long as the image IM1 is an image that is provided to the second terminal apparatus 8 from the server apparatus 7. For example, the output process unit 717 may select an output destination in accordance with a distribution condition that is defined in the declaration information or the like and output the information to an output destination to which distribution is permitted.

An image IM2 shown in FIG. 7B is an example of an image displaying a driving situation in a predetermined period. In this image, the evaluation target period, a total driving time, a point, and the like are displayed. The point will be described later. Further, as an evaluation result, a “score” (Z21) that is obtained by quantifying the evaluation result and graphs showing histories of a sudden braking number (Z22), a sudden acceleration number (Z23), and a speeding period (Z24) are shown. This graph is an example of a case where each of the sudden braking number, the sudden acceleration number, and the speeding period tends to decrease substantially with respect to an increase of the total driving time. Furthermore, in the image IM2, a plurality of evaluation target periods (Z25), a total driving time (Z26), a point (Z27), and the like are displayed. The point will be described later.

An image IM3 shown in FIG. 7C is an example of an image in which each evaluation result is modelled and displayed for each item of the evaluation result. In this image, icons corresponding to the items of the evaluation result are arranged in a grid pattern. When a specific event occurs at the driving of the evaluation target, for example, the output process unit 717 changes a display of an icon corresponding to the event from a display of a case where the event does not occur and displays the icon.

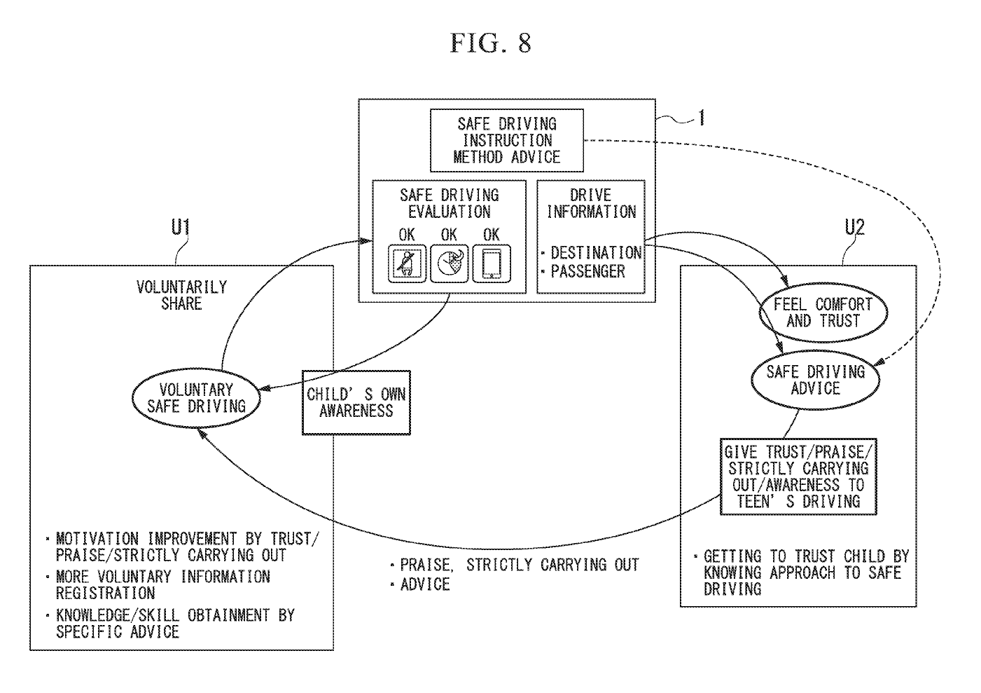

FIG. 8 is a view showing the usefulness of the driving evaluation system 1 according to the first embodiment.

The user U1 uses the driving evaluation system 1 when driving the vehicle 3A (3B). The user U1 drives further safely voluntarily while keeping it in mind and voluntarily shares the information relating to the driving using the first terminal apparatus 2.

The first terminal apparatus 2 provides the evaluation result of the driving of the user U1 on the basis of the shared information. The user U1 analyzes the evaluation result, and thereby, awareness with respect to safe driving arises at the user U1.

The first terminal apparatus 2 provides the above evaluation result of the driving of the user U1 to the second terminal apparatus 8, for example, via the server apparatus 7.

By the evaluation result being provided to the second terminal apparatus 8, the user U2 is able to check that the user U1 is strictly carrying out safe driving and feel comfortable and is able to trust the user U1. On the other hand, when there is a point to be improved in driving skill and the like, it is possible to give an advice for driving further safely to the user U1. Thereby, the user U2 may notify the user U1 of that the user U2 is able to trust the driving of the user U1 from the evaluation result, that the user U2 is able to confirm that the user U1 was strictly carrying out safe driving, and the like and praise the user U1. Further, the user U2 is able to act so as to give an advice, a suggestion, or autonomous awareness about the skill for driving safely, if necessary.

The users U1 and U2 are able to refer to an objectively evaluated result individually or together, and by sharing information such as the evaluation result relating to the driving of the vehicle 3A, it is possible to facilitate communication between a parent and his/her child.

Further, the user U1 confirms that it is acknowledged that he/she was strictly carrying out safe driving, knows that he/she is trusted for the driving, receives praise, and is thereby confident in driving. Thereby, further, the motivation of enhancing the skill at the user U1 is improved. Further, the user U1 is able to acquire knowledge relating to the skill by the advice, the suggestion, and the like from the parent and enhance the skill of the driving technique.

According to the first embodiment described above, the server apparatus 7 calculates the full period evaluation result (driving evaluation result) relating to the evaluation of the driving of the driver on the basis of the driving information relating to the driving of the driver (the user U1) of the vehicle 3A, determines the timing at which the full period evaluation result is output for each output destination on the basis of the output destination which is stored in the storage part 720 that stores the information of the output destination to which the full period evaluation result is output, outputs the full period evaluation result in accordance with the timing that is determined for each output destination, and is thereby able to provide the full period evaluation result in which the skill of the driver relating to the driving of the vehicle 3A is evaluated through a desired period.

Further, it becomes possible to perform moderate output in accordance with the output destination.

The server apparatus 7 limits a period during which the information is provided to the timing at which the full period evaluation result is output as described above, and thereby, the users U1 and U2 are able to acquire the information including a required full period evaluation result at a timing that is registered in advance.

The driving evaluation system 1 reduces the burden that the users U1 and U2 feel in acquiring the information described above. The driving evaluation system 1 provides the evaluation result and the like to the user U1, the user U2, and the like at a moderate frequency and thereby contributes to promoting the use of the driving evaluation system 1.

### Second Embodiment

A second embodiment is described. The first embodiment is described using an example in which the first terminal apparatus 2 as a driving evaluation apparatus is used within the vehicle 3A. On the other hand, the second embodiment is described using an example in which, instead of the first terminal apparatus 2, an in-vehicle information apparatus 4B that is mounted on in the vehicle 3B is used.

As shown in FIG. 1 described above, the in-vehicle information apparatus 4B (driving evaluation apparatus) and the ECU 5B are connected together by a network NWB in the vehicle 3B. A communication apparatus 6B is connected to the in-vehicle information apparatus 4B.

The in-vehicle information apparatus 4B communicates with the server apparatus 7 via the network NW through the communication apparatus 6B.

In the in-vehicle information apparatus 4B, each functional part for performing the travel evaluation process instead of the first terminal apparatus 2 according to the first embodiment is added to the in-vehicle information apparatus 4A. The in-vehicle information apparatus 4B displays a variety of information relating to the vehicle 3B on the display part instead of the first terminal apparatus 2.

The ECU 5B controls driving, braking, steering, and the like of the vehicle 3B. The communication apparatus 6B transmits the vehicle data relating to the driving of the user U1 to the server apparatus 7. That is, the communication apparatus 6B functions as an interface for connecting the in-vehicle information apparatus 4B to the network NW.

### [In-Vehicle Information Apparatus 4B]

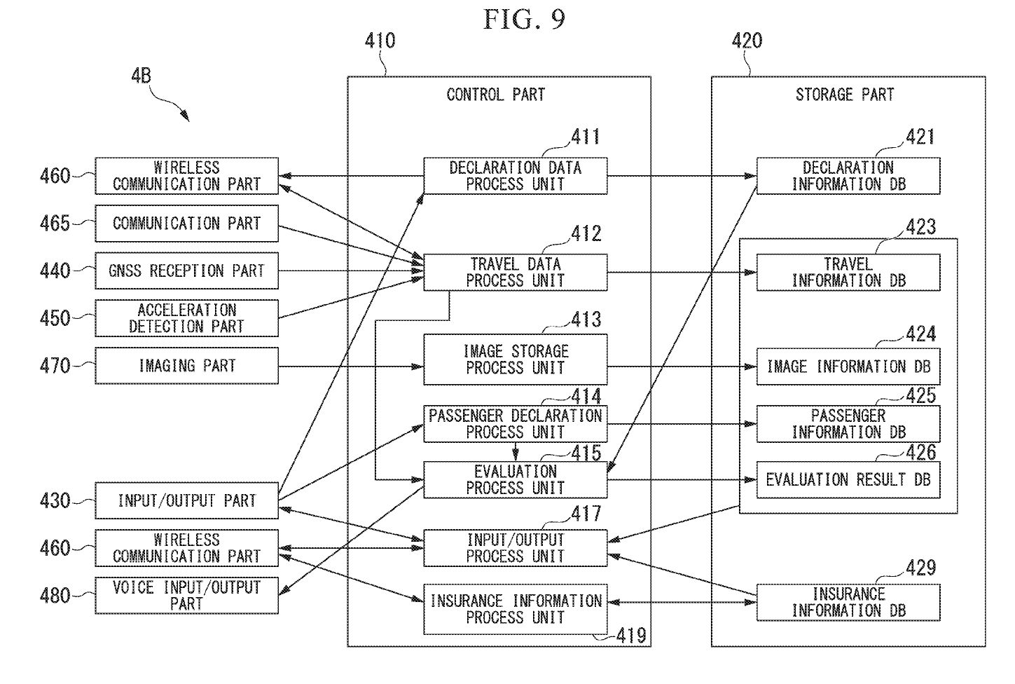

FIG. 9 is a configuration view of the in-vehicle information apparatus according to the second embodiment. The in-vehicle information apparatus 4B includes, for example, a control part 410, a storage part 420, an input/output part 430, a GNSS reception part 440, an acceleration detection part 450, a wireless communication part 460, a communication part 465, an imaging part 470, and a voice input/output part 480.

Each of the control part 410, the storage part 420, the input/output part 430, the GNSS reception part 440, the acceleration detection part 450, the wireless communication part 460, the imaging part 470, and the voice input/output part 480 has a function similar to each of the control part 210, the storage part 220, the input/output part 230, the GNSS reception part 240, the acceleration detection part 250, the wireless communication part 260, the imaging part 270, and the voice input/output part 280 of the first terminal apparatus 2.

The communication part 465 communicates with the ECU 5B. The communication part 465 collects travel data and the like that are transmitted from the ECU 5B onto the network NWB.

The control part 410 includes, for example, a declaration data process unit 411, a travel data process unit 412, an image storage process unit 413, a passenger declaration process unit 414, an evaluation process unit 415, an input/output process unit 417, and an insurance information process unit 419. The declaration data process unit 411, the travel data process unit 412, the image storage process unit 413, the passenger declaration process unit 414, the evaluation process unit 415, the input/output process unit 417, and the insurance information process unit 419 have a function similar to the declaration data process unit 211, the travel data process unit 212, the image storage process unit 213, the passenger declaration process unit 214, the evaluation process unit 215, the input/output process unit 217, and the insurance information process unit 219 of the first terminal apparatus 2.

Detailed description is omitted by replacing the description of FIG. 2 by the following description.

An apparatus that is operated by the user U1 in the vehicle 3B is changed from the first terminal apparatus 2 to the in-vehicle information apparatus 4B. However, it is possible to reduce the operation of the user U1 by a configuration as described below. For example, instead of the user U1 operating the button that is displayed on the input/output part 230 (at the time of driving start) and (at the time of driving end), from the travel data that are acquired by the travel data process unit 412, the driving start of the user U1 is detected by detecting that an operation (IG ON or the like) for permitting the generation of a thrust of the vehicle 3B is performed, and the driving end of the user U1 is detected by detecting that an operation (IG OFF or the like) for limiting the generation of the thrust of the vehicle 3B is performed. Thereby, the in-vehicle information apparatus 4B is able to control the start and the end of the travel evaluation process, and it is possible to reduce the operation of the button described above of the user U1.

Regarding the browsing of the evaluation result after the driving end, the user U1 may browse the evaluation result that is provided from the server apparatus 7 by using an arbitrary terminal apparatus that is registered in advance.

The server apparatus 7 performs a process with respect also to the vehicle data that is transmitted from the in-vehicle information apparatus 4B similar to the vehicle data that is transmitted from the first terminal apparatus 2 described above.

According to the second embodiment, an effect similar to the first embodiment is obtained. In the case of the second embodiment, when the user U1 drives the vehicle 3B, the user U1 may board the vehicle 3B without carrying the first terminal apparatus 2. The in-vehicle information apparatus 4B functions as a driving evaluation apparatus instead of the first terminal apparatus 2.

### Third Embodiment

A third embodiment is described. The first embodiment and the second embodiment are described using an example in which the server apparatus 7 determines the timing at which the evaluation result is output, but instead of this, the third embodiment is described using an example in which the first terminal apparatus 2 determines the timing at which the evaluation result is output.

The above-described driving evaluation system 1 shown in FIG. 1 is replaced by a driving evaluation system 1C, the first terminal apparatus 2 is replaced by a first terminal apparatus 2C, and the server apparatus 7 is replaced by a server apparatus 7C. Hereinafter, the driving evaluation system 1C is described using an example of the vehicle 3A, but the description can be applied similarly to the vehicle 3B. The description here is omitted.

### [First Terminal Apparatus 2C]

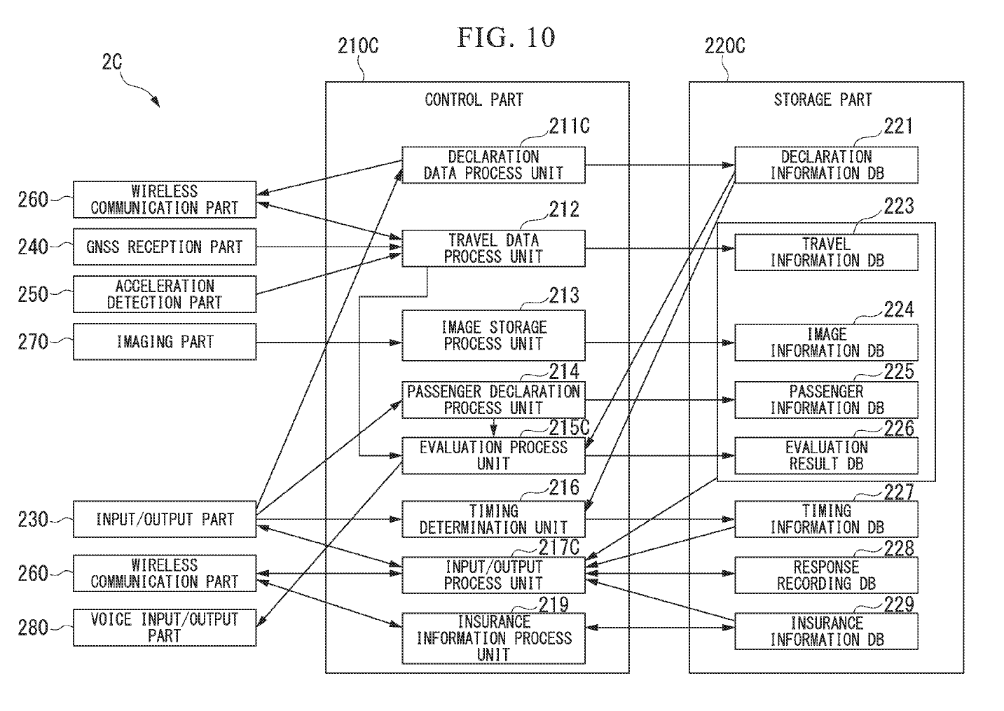

First, the first terminal apparatus 2C according to the third embodiment is described. FIG. 10 is a configuration view of a terminal apparatus according to the third embodiment.

The first terminal apparatus 2C includes, for example, a control part 210C, a storage part 220C, the input/output part 230, the GNSS reception part 240, the acceleration detection part 250, the wireless communication part 260, the imaging part 270, and the voice input/output part 280.

The control part 210C includes, for example, a declaration data process unit 211C, the travel data process unit 212, the image storage process unit 213, the passenger declaration process unit 214, an evaluation process unit 215C (driving evaluation calculation part), a timing determination unit 216, an input/output process unit 217C, and the insurance information process unit 219.

The storage part 220C stores, for example, the declaration information DB 221, the travel information DB 223, the image information DB 224, the passenger information DB 225, the evaluation result DB 226, a timing information DB 227, a response recording DB 228, the insurance information DB 229, and the like.

The declaration data process unit 211C is constituted by deleting the function in which part (timing information) of the acquired variety of information is sent to the server apparatus 7 from the function of the declaration data process unit 211 described above.

The evaluation process unit 215C is constituted by deleting “a function in which the vehicle data is transmitted to the server apparatus 7 after evaluating the item relating to the presence or absence of the passenger” from the function of the evaluation process unit 215 described above. That is, the first terminal apparatus 2C does not transmit the vehicle data itself to the server apparatus 7C.

The timing determination unit 216 and the timing information DB 227 are similar to the timing determination unit 716 and the timing information DB 727 described above. The timing determination unit 216 determines the timing at which the evaluation result is output for each output destination of the evaluation result and registers the timing to the timing information DB 227.

The following item is added to the input/output process unit 217 to constitute the input/output process unit 217C. In accordance with the timing that is registered in the timing information DB 727, the input/output process unit 217C outputs the evaluation result to each predetermined output destination.

### [Server Apparatus 7C]

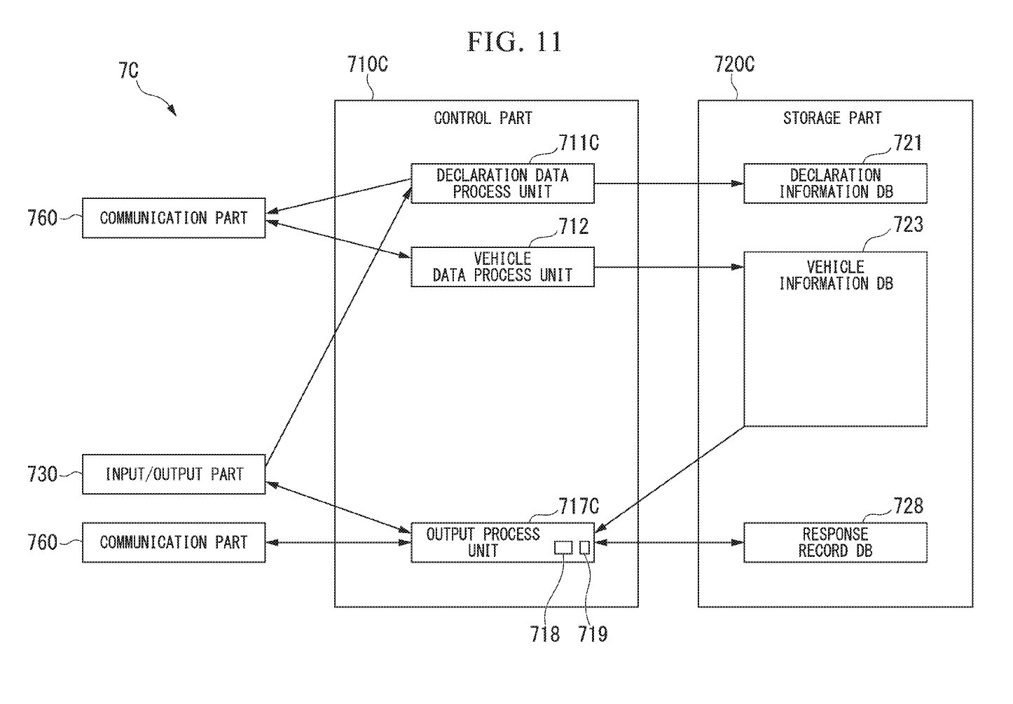

Next, the server apparatus according to the third embodiment is described. FIG. 11 is a configuration view of the server apparatus according to the third embodiment. The server apparatus 7C includes, for example, a control part 710C, a storage part 720C, the input/output part 730, and the communication part 760.

In the server apparatus 7C, the control part 710C includes, for example, a declaration data process unit 711C, the vehicle data process unit 712, and an output process unit 717C. That is, in the control part 710C, the timing determination unit 716 is deleted from the control part 710.

The declaration data process unit 711C acquires a variety of information that is declared by the operation of the first terminal apparatus 2C or the like of the user U1 and adds the information to the declaration information DB 721.

The vehicle data process unit 712 acquires the vehicle data from the first terminal apparatus 2 and adds the vehicle data to the vehicle information DB 723.

The storage part 720C stores the declaration information DB 721, the vehicle information DB 723, and the like.

Next, an output process by the server apparatus 7C is described. The server apparatus 7C is different from the server apparatus 7 described above in that the server apparatus 7C does not include the function of determining and adjusting the frequency and the timing relating to the transmission to the output destination. Therefore, the server apparatus 7C acquires the information that is transmitted from the first terminal apparatus 2C or the like and forwards the information to the output destination in accordance with the timing at which the information is acquired.

In the third embodiment, the server apparatus 7 may be replaced by a relay apparatus such as a so-called router.

According to the third embodiment described above, it is possible to obtain an effect similar to the first embodiment.

### Fourth Embodiment

A fourth embodiment is described. In the fourth embodiment, a function in which an offer (an advertisement, a discount rate, and the like) from the insurance company is displayed on the first terminal apparatus 2 or the like is added to the driving evaluation system 1 or the like of the first to third embodiments.

An outline of the fourth embodiment is described on the basis of the configurations of the first embodiment and the second embodiment with reference to FIG. 1 described above. The present invention is not limited thereto and may be applied to the configuration of the third embodiment.

The output destination from the server apparatus 7 includes the insurance premium calculation apparatus 9 of the insurance company. When the full period evaluation result satisfies a predetermined condition that is set in advance, the server apparatus 7 transmits the full period evaluation result to the insurance premium calculation apparatus 9 of the insurance company. The predetermined condition is, for example, that a value indicated by the full period evaluation result is a predetermined score (predetermined value) or more, that the full period evaluation result is given a higher valuation than previous results, or the like.

The insurance premium calculation apparatus 9 acquires the full period evaluation result, calculates a discount rate with respect to a basic contract amount of the insurance contract, and transmits information for offering a recommended insurance contract to the output destination of the first terminal apparatus 2 or the like. The information relating to the offer of the recommended insurance contract includes, for example, a feature of the recommended insurance contract, a basic contract amount, a discount rate, an advertisement, and the like.

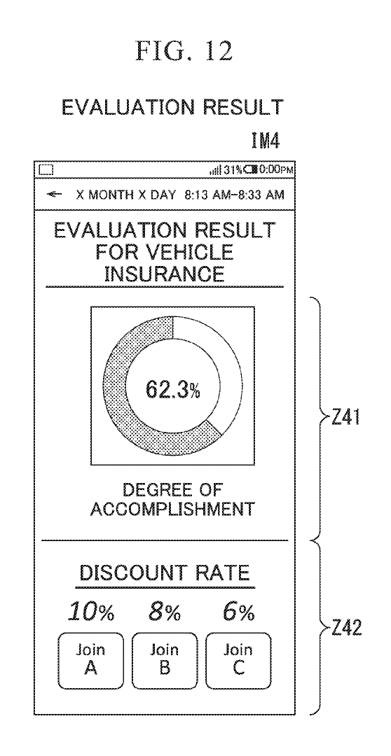

An example of an evaluation result image that is displayed on the terminal apparatus or the like is described with reference to FIG. 12.

FIG. 12 is a view showing the evaluation result image showing the information relating to the insurance contract according to the fourth embodiment. The full period evaluation result is displayed as a pie chart on an upper side in an image IM4, the information relating to the discount rate that is acquired from the insurance company is displayed on a lower side, and each of the full period evaluation result and the information relating to the discount rate is arranged so as to fit within the image IM4. The image IM4 is an example of the evaluation result image (information) that displays the full period evaluation result and the information relating to the insurance contract on the same screen. In this example, it is shown that a discount rate of 10% is offered from insurance company A, a discount rate of 8% is offered from insurance company B, and a discount rate of 6% is offered from insurance company C. The discount rates described above are determined in accordance with calculation standards of each of the insurance companies. For example, the above-described discount rate increases as the evaluation result of the driving of the policyholder is good.

In this way, the full period evaluation result and the information relating to the insurance contract are displayed together, and thereby, it is possible to compare and check the evaluation result and the discount rate of the insurance contract.

For example, in a case where an expected discount rate is not satisfied, the user U1 notices that there is a possibility that the discount rate may increase by improving the item of which the evaluation value is low during the evaluation period.

In this way, in a case where the quantitative evaluation result is improved by keeping further safe driving in mind daily, the discount rate of the insurance premium is further improved. The discount rate of the insurance premium described above contributes to enhancing the motivation for strictly carrying out safe driving.

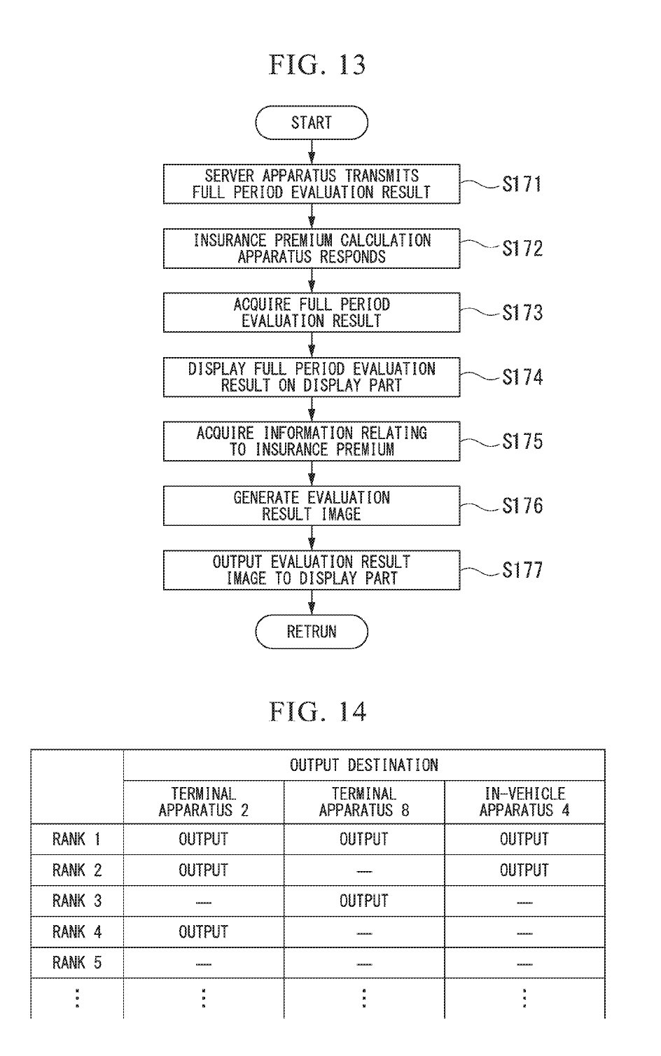

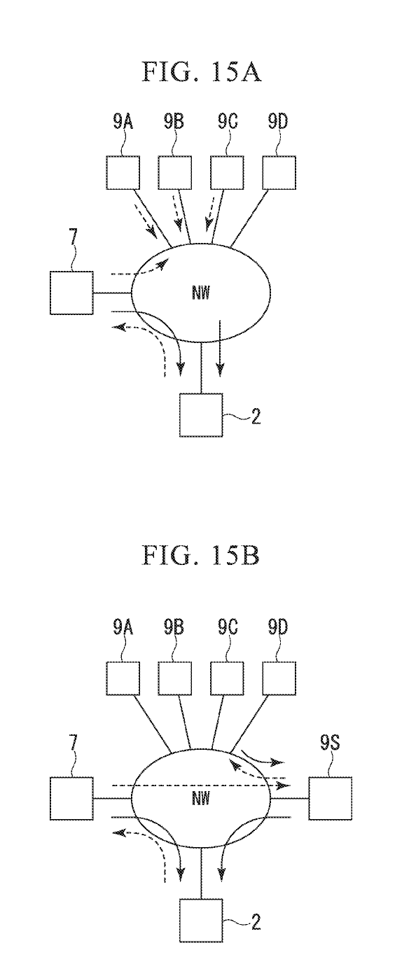

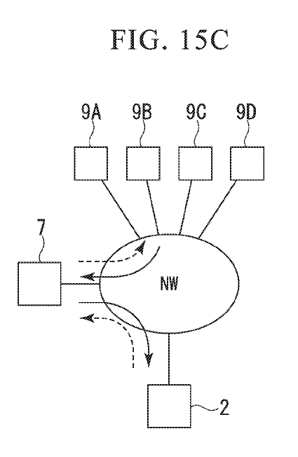

With reference to FIG. 13, a process relating to generation of the evaluation result image is described while assuming a case in which the server apparatus 7 sends the full period evaluation result to insurance premium calculation apparatuses 9A to 9D of insurance companies (refer to FIG. 15A which will be described later). Each of the insurance premium calculation apparatuses 9A to 9D is provided in each of the insurance companies A to D and has a function similar to the insurance premium calculation apparatus 9 described above.

FIG. 13 is a flowchart showing an example of a flow of a synthesis process of the evaluation result image according to the fourth embodiment.

First, the server apparatus 7 transmits a full period evaluation result that satisfies a predetermined condition that is set in advance to each of the insurance premium calculation apparatuses 9A to 9D (Step S171). In accordance with this, the server apparatus 7 transmits the full period evaluation result to the first terminal apparatus 2 and the second terminal apparatus 8 that satisfy a predetermined condition.

Next, the insurance premium calculation apparatuses 9A to 9C respond to this full period evaluation result (Step S172).

Next, the input/output process unit 217 (driving evaluation acquisition unit) of the first terminal apparatus 2 acquires the full period evaluation result from the server apparatus 7 (Step S173). The full period evaluation result is an example of the information obtained by quantifying the evaluation of the driving of the driver on the basis of the driving information relating to the driving of the driver of the vehicle. Next, the input/output process unit 217 (driving evaluation output unit) allows the input/output part 230 to output the acquired full period evaluation result (Step S174).

Next, the insurance information process unit 219 acquires the information relating to the insurance premium from each of the insurance premium calculation apparatuses 9A to 9C (Step S175) and registers the information relating to the insurance premium to the insurance information DB 229.

Next, the input/output process unit 217 generates the image IM4 that is a combination of the full period evaluation result and the information relating to the insurance premium relating to the driving of the vehicle 3A of each company on the basis of the full period evaluation result and the information relating to the insurance premium relating to the driving of the vehicle 3A of each company (Step S176) and allows the image IM4 to be output onto the display unit of the input/output part 230 (Step S177).

FIG. 14 is a view showing a condition for determining the output destination according to the fourth embodiment. Information for determining whether or not an output to each of a plurality of output destinations is permitted is stored in a table shown in FIG. 14. For example, this table is used when ranking the driving skill of the driver. Rank 1 indicates that the driving skill is proficient, and as a numerical value of the rank increases, the rank indicates that the skill is less proficient. This ranking may be used as an alternative to the evaluation on the strict carrying out of safe driving.

For example, when the rank is evaluated as rank 1, all of the output destinations that are registered in this table are permitted as the distribution destination of the information relating to the insurance premium.

When the rank is determined to be rank 2, the first terminal apparatus 2 (the user U1) and the in-vehicle information apparatus 4 (4B) are permitted as the output destinations. When the rank is determined to be rank 3, the second terminal apparatus 8 (the user U2) is permitted as the output destination. When the rank is determined to be rank 4, the first terminal apparatus 2 is permitted as the output destination.

In this way, by the determination using the table described above, when the full period evaluation result does not satisfy the predetermined condition, the input/output process unit 217 is able to limit the distribution destination of the information relating to the insurance premium. For example, the server apparatus 7 stores the table described above in the storage part 720C.

For example, the user U2 may be part or all of an owner of the vehicle 3A, a policyholder of the automobile insurance of the vehicle 3A, and a holder of an insurance card of the automobile insurance of the vehicle 3A.

For example, the server apparatus 7 determines a method in which the distribution destination is limited by the information relating to the table described above uniformly for each user.

In a case of setting individually, the first terminal apparatus 2 may store the information relating to the table described above in the declaration information DB 221, send the information relating to the table to the server apparatus 7 while including the information relating to the table in the declaration information, and allow the server apparatus 7 to select the output destination. The server apparatus 7 transmits the output destination to the insurance premium calculation apparatuses 9A to 9D. Thereby, the insurance premium calculation apparatuses 9A to 9D are able to transmit the information relating to the insurance premium only to the output destination that is reported from the server apparatus 7.

As a more specific first example, when the user U1 designates a table in which any of rank 1 and rank 5 is a candidate of selection, in a case where the full period driving evaluation is less than a predetermined value, the server apparatus 7 is able to designate that the information relating to the insurance premium is not output to both the first terminal apparatus 2 of the user U1 as a driver and the second terminal apparatus 8 of the user U2 as an owner of the vehicle 3A (rank 5).

Further, as a second example, when the user U1 designates a table in which any of rank 1 and rank 4 is a candidate of selection, for example, in a case where the full period driving evaluation is less than the predetermined value, the server apparatus 7 is able to designate that the information relating to the insurance premium is output to the user U1 as the driver but is not output to the user U2 as the owner of the vehicle (rank 4).

Next, a usage mode according to the fourth embodiment is described with reference to FIGS. 15A to 15C. FIGS. 15A to 15C are views showing the usage mode according to the fourth embodiment. As shown in FIGS. 15A to 15C, the following several cases are conceivable for a configuration on the insurance company side.

Case 1: Usage mode in which the server apparatus 7 sends the full period evaluation result to the insurance premium calculation apparatuses 9A to 9D of the insurance companies (FIG. 15A).

In case 1, the first terminal apparatus 2 waits individually for a response from each of the insurance companies.

For a detailed description, FIG. 13 described above is referred to.

Case 2: Usage mode in which the server apparatus 7 sends the full period evaluation result to an insurance premium calculation apparatus 9S of a referral company that mediates the insurance company (FIG. 15B).

In case 2, when the insurance premium calculation apparatus 9S sends the full period evaluation result to the insurance premium calculation apparatuses 9A to 9D of the insurance companies, the insurance premium calculation apparatus 9S acquires a response (the information relating to the insurance premium) from each of the insurance premium calculation apparatuses 9A to 9D. The insurance premium calculation apparatus 9S gives a priority to the acquired information relating to the insurance premium in accordance with a predetermined condition and sends integrally the information relating to the insurance premium to the first terminal apparatus 2. In this case, the first terminal apparatus 2 is able to allow the number of times at each of which a response from the insurance company is waited for to be one time.

Case 3: A case where the server apparatus 7 sends the full period evaluation result to the insurance premium calculation apparatuses 9A to 9D, and the server apparatus 7 receives responses from the insurance premium calculation apparatuses 9A to 9D (FIG. 15C).

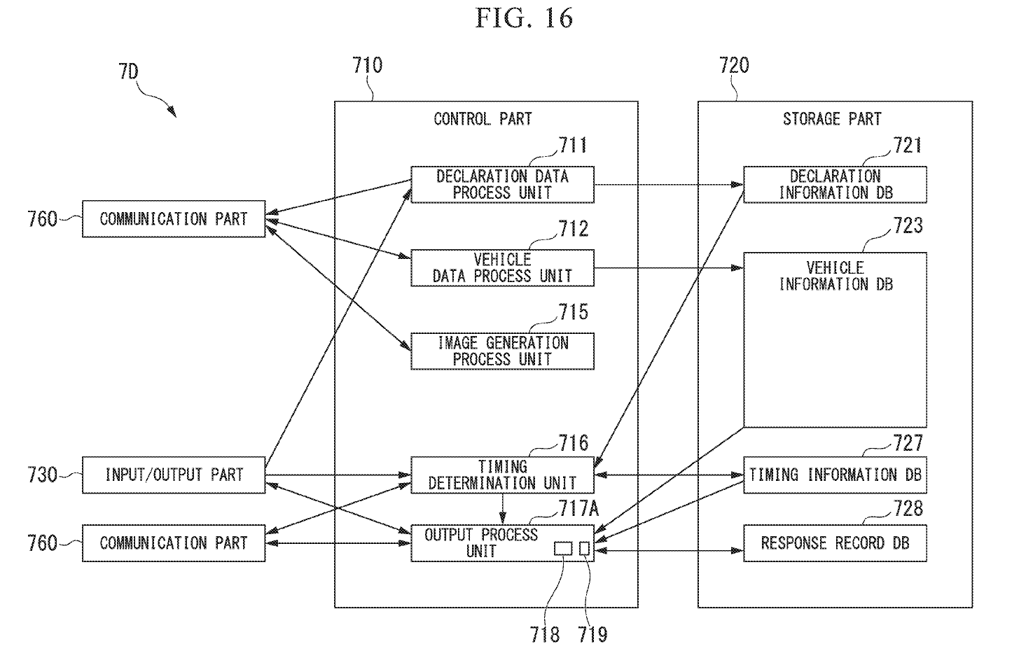

With respect to case 3, a server apparatus 7D that is applied to case 3 is described with reference to FIG. 16. FIG. 16 is a configuration view of the server apparatus 7D that is applied to a modified example (Case 3) according to the fourth embodiment.

The server apparatus 7D further includes an image generation process unit 715 with respect to the server apparatus 7. The image generation process unit 715 generates the image IM4 instead of each terminal apparatus or the like. The server apparatus 7D distributes the image IM4 to each terminal apparatus or the like.

For example, after the image generation process unit 715 receives the responses from the insurance premium calculation apparatuses 9A to 9D, the image generation process unit 715 generates the image IM4 on the basis of the full period evaluation result and the information relating to the premium of each company. An input/output process unit 717A transmits the generated image IM4 to the first terminal apparatus 2 or the like that is permitted as the output destination. Each terminal apparatus receives the image IM4 and displays the image IM4 on the display part of each terminal apparatus.

The display image shown in FIG. 12 described above is an example and is not limited thereto. For example, when the discount rate is reported from the insurance company, the first terminal apparatus 2 may list and display all of the reported discount rates or may switch and display part of the reported discount rates. In this case, the user U1 is able to read a tendency of how the evaluation result of the user U1 is assessed from a tendency of the discount rate of each company. In this way, when the first terminal apparatus 2 displays even a case where the discount rate is relatively small, the first terminal apparatus 2 contributes to the user U1 avoiding a driving by which the discount rate becomes small.

The first terminal apparatus 2 may arrange the companies in a descending order of the discount rates that are reported from the insurance companies and display some or all of the companies and may arrange and display the companies in the order of acquisition on the basis of all of the reported responses. In this case, the user U1 is able to read the tendency of how the evaluation result of the user U1 is assessed from the tendency of the discount rate of each company.

The automobile insurance described above may be referred to as a user based insurance (UBI). The UBI includes a driving behavior interlocking type (PHYD: Pay How You Drive) and a travel distance interlocking type (PAYD: Pay As You Drive). Although the automobile insurance described above as an example relates to the driving behavior interlocking type, the present invention is not limited thereto. The present invention can be applied to the travel distance interlocking type.

According to the fourth embodiment described above, in addition to the effect similar to the first embodiment, the determination result of the insurance company as a result of determination of a third party is able to be used as the information for improving one's driving skill. Even though a determination standard of the insurance of the insurance company is concealed, according to the fourth embodiment, it is possible to obtain the result of the determination of the driving skill according to the determination standard.

Further, according to the fourth embodiment described above, the full period evaluation result obtained by evaluating the driving of the user U1 is acquired, the calculated driving evaluation result is output, and in a case where the calculated driving evaluation result satisfies a predetermined condition, the driving evaluation result and the information relating to the insurance premium regarding the driving are combined with each other and output. Thereby, in a case where the driving evaluation is high, the insurance premium or the discount rate of the insurance premium is presented together with the driving evaluation. Therefore, the user U1 (the vehicle driver) and the user U2 (the owner of the vehicle) can easily recognize how the user U1 is evaluated, and it is possible to clearly present an improvement point.

### Modified Example of Fourth Embodiment

A modified example of the fourth embodiment is described. The server apparatus 7 according to the fourth embodiment transmits the full period evaluation result which satisfies a predetermined condition that is set in advance to the insurance premium calculation apparatus 9 of the insurance company. Alternatively, the server apparatus 7 of the modified example may also transmit a full period evaluation result which does not satisfy the “predetermined condition” to the insurance premium calculation apparatus 9 of the insurance company.

In this case, the first terminal apparatus 2 implements the determination of the “predetermined condition”. According to this, in a case where the predetermined condition is satisfied, the first terminal apparatus 2 is able to generate the image IM4, and it is possible to provide an effect similar to as the fourth embodiment.

### Fifth Embodiment

A fifth embodiment is described. In the fifth embodiment, a function of making use of a point that is given by the present system to the contract with the insurance company shown in the fourth embodiment is added to the fourth embodiment.

The point use is described with reference to FIG. 3 described above.

The response acquisition section 718 acquires a response of the user U2 who is the owner of the vehicle 3A to the full period driving evaluation that is transmitted to the second terminal apparatus 8 or the like.

In a point process section 719, a point assignment rule is determined such that a point is given to the owner of the vehicle 3A when the owner of the vehicle 3A acquires the response to the driving evaluation that is output by the input/output process unit 217. For example, the owner described above is able to use the point at a stage of newly signing up for an automobile insurance. At that time, the point that is allocated by the point process section 719 may be allocated to part of the output insurance premium, and the premium may be set to be reduced by the point.

Funds of the point in this case may be absorbed by a company (insurance company or the like) that presents the insurance premium to any one or both of the users U1 and U2.

The insurance company is able to propose information relating to an insurance service of the company and information relating to a discount rate that will be advantageous to a policyholder to an owner who is keeping safe driving in mind. When it is possible to contract with such an owner, it is possible to increase the number of customers who safely drive. It is estimated that such an owner has a low risk of occurrence of payment due to an accident or the like. Accordingly, even when a certain degree of discount is set, it is assumed that increasing the number of contracts contribute to an increase in profit, and the insurance company is able to absorb the funds of the point described above.

On the other hand, when the driver of the vehicle 3A according to the above-described insurance contract keeps safe driving in mind daily, a possibility that the driver is involved in an accident or the like becomes low. Further, an insurance policyholder is able to benefit from strictly carrying out safe driving daily when contracting an insurance and is able to sign up for an insurance of similar service contents at a price that is discounted from a standard contract price or the like.

According to the fifth embodiment, in addition to providing an effect similar to the first embodiment, it is possible to embody and use the result of the daily safe driving as a point.

Next, a display of the evaluation result common to the embodiments is described with reference to FIG. 17. FIG. 17 is a view showing an image showing the evaluation result according to the embodiment. The full period evaluation result is displayed as a bar graph on an upper side of an image IM5, and a “DRIVE” button and a “score” button are displayed on a lower side. In the image IM5, a past evaluation result and a current evaluation result are displayed on the bar graph in contrast to each other.

The user U1 is able to read how the evaluation result has changed relative to the past evaluation result by displaying the image IM5 on the first terminal apparatus 2. Further, it is possible to start recording for evaluation by operating the “DRIVE” button shown on the lower side.

While preferred embodiments of the invention have been described, the invention is not limited to the embodiments described above, and a variety of modifications and replacements can be made without departing from the scope of the invention.

What is claimed is:

1. A driving evaluation apparatus, comprising:
a driving evaluation acquisition part that is configured to acquire a driving evaluation result which is obtained by evaluating a driving of a driver of a vehicle; and
a driving evaluation output part that is configured to output the acquired driving evaluation result,
wherein the driving evaluation output part is configured to combine and output the driving evaluation result and information relating to an insurance premium regarding the driving in a case where the acquired driving evaluation result satisfies a predetermined condition.

2. The driving evaluation apparatus according to claim 1,
wherein the driving evaluation output part is configured to combine and output the driving evaluation result and the information relating to the insurance premium in a case where a value that is indicated by the driving evaluation result is equal to or more than a predetermined value.

3. The driving evaluation apparatus according to claim 1, further comprising
a driving information acquisition part that is configured to acquire driving information relating to the driving of the driver of the vehicle.

4. The driving evaluation apparatus according to claim 1,
wherein the driving evaluation output part is configured to generate information for displaying the driving evaluation result which is stored in a storage part and the information relating to the insurance premium in a same screen.

5. The driving evaluation apparatus according to claim 1,
wherein the driving evaluation output part further comprises a display part that is configured to display the driving evaluation result which is stored in a storage part and the information relating to the insurance premium.

6. The driving evaluation apparatus according to claim 4,
wherein at least one of contact information of the driver of the vehicle and contact information of a payer of the insurance premium of the vehicle and an owner of the vehicle is stored in the storage part as one or more output destinations of information of one or both of the driving evaluation result and the information relating to the insurance premium regarding the driving, and
the driving evaluation output part is configured to output the driving evaluation result and the information relating to the insurance premium to at least one of the output destinations.

7. The driving evaluation apparatus according to claim 6, comprising:
a response acquisition part that is configured to acquire a response of the owner of the vehicle to the driving evaluation result which is output by the driving evaluation output part; and
a point process part that is configured to give a point to the owner of the vehicle when acquiring the response of the owner of the vehicle to the driving evaluation result which is output by the driving evaluation output part,
wherein the point is assigned to part of the output insurance premium, and the insurance premium is set to be reduced by the point.

8. A driving evaluation system, comprising:
a driving information acquisition part that is configured to acquire driving information relating to a driving of a driver of a vehicle;
a driving evaluation calculation part that is configured to calculate a driving evaluation result which is obtained by evaluating the driving of the driver according to the driving information that is acquired by the driving information acquisition part; and
a driving evaluation output part that is configured to output the driving evaluation result which is calculated by the driving evaluation calculation part,
wherein the driving evaluation output part is configured to combine and output the driving evaluation result and information relating to an insurance premium regarding the driving in a case where the driving evaluation result that is calculated by the driving evaluation calculation part satisfies a predetermined condition.

9. A computer-readable non-transitory recording medium which comprises a program that is configured to cause a computer to execute steps of:
acquiring driving information relating to a driving of a driver of a vehicle;
acquiring a driving evaluation result which is an evaluation result of the driving of the driver according to the acquired driving information; and
outputting the acquired driving evaluation result, and combining and outputting the driving evaluation result and information relating to an insurance premium regarding the driving in a case where the acquired driving evaluation result satisfies a predetermined condition.
